(19) United States
(12) Patent Application Publication
(10) Pub. No.: US 2014/0173405 A1
(43) Pub. Date: Jun. 19, 2014

(54) USING CUSTOM FUNCTIONS TO DYNAMICALLY MANIPULATE WEB FORMS

(71) Applicant: Google Inc., Mountain View, CA (US)

(72) Inventors: DANIEL ENRIQUE FERRARA, NEW YORK, NY (US); JOSEPH ROBERT TESSLER, AUSTIX, TX (US); MATTHEW JACOB ZIEGELBAUM, GREAT NECK, NY (US)

(21) Appl. No.: 13/720,663

(22) Filed: Dec. 19, 2012

(51) Int. Cl. G06F 17/24

(52) U.S. Cl. CPC G06F 17/243
USPC 715/223

(57) ABSTRACT

A system and method for dynamically modifying web forms in a hosted form application execution environment is disclosed. A web form can be generated for displaying and collecting information from an end user. A trigger can be created that executes on a specific trigger event. When the specified trigger event occurs, a script may be automatically executed to dynamically alter the web form. Then, the altered web form can be displayed to the end user.

### BACKGROUND

Web forms are useful tools for collecting data. People use web forms for a variety of functions including planning events, sending surveys, creating quizzes for students, and generally for collecting information in an easy, streamlined way. Web forms allow end users to enter data on a web page and send the data to a server for processing. Input from form fields can be stored in a database, a spreadsheet, or some other remote storage in which data can be readily manipulated and analyzed.

However, creating web forms can be time-consuming and labor-intensive. Developing a web form from scratch can require skills, such as advanced knowledge of HTML, javascript, and backend coding languages that the average person does not possess. Since hiring software developers to build web forms can be prohibitively expensive, web form builder applications have been developed so that people with limited programming experience can create and publish professional-quality web forms without having to learn how to code. Form building applications are usually provided by form services in hosted form application execution environments. Form service providers often provide users access to form builder applications and tools via a user interface. For example, through a user interface in a hosted form application execution environment, a user may create an event registration form as illustrated in FIG. 1. The user may enter text regarding the event registration that will be displayed to an end user along with possible answer choices.

Although form-building applications allow users to quickly and easily create forms, most form building applications only permit users to create static forms that do not change without manual manipulation. A static form displays form content, but the form content remains the same regardless of previous responses entered into form fields or any changes in the form application. However, there are many situations in which form input fields are tightly coupled with previous user responses or application changes. For example, suppose for the event registration form discussed above the first one hundred people to register for the event will receive a free t-shirt. The person building the form for event registration may want to collect a t-shirt size from the first one hundred people to register so that the registrants can receive their free t-shirt in the correct size. The form should therefore display an option for selecting a t-shirt size, as illustrated in FIG. 1. After the one hundredth person registers, there is no need to collect t-shirt sizes because no more t-shirts will be given out. The form should therefore no longer display the input field for collecting information regarding t-shirt size. Conventional form building applications do not provide tools for dynamically altering a form in order to modify the displayed form fields based on previous responses to fields on the form or to changes in the form application, such as reaching one hundred registrants. There should be a way to dynamically alter a form to change the displayed contents and also to validate form field input.

### SUMMARY

This specification describes technologies relating to web form in general, and specifically to methods and systems for using custom functions to dynamically manipulate web form schemas and content.

In general, one aspect of the subject matter described in this specification can be embodied in a system and method for dynamically modifying a web form in a hosted form application execution environment. An exemplary system includes: one or more processing devices and one or more storage devices storing instructions that, when executed by the one or more processing devices, cause the one or more processing devices to create a defined web form structure and create a script to run when a trigger even occurs that alters the defined web form structure. A second exemplary system includes: one or more processing devices and one or more storage devices storing instructions that, when executed by the one or more processing devices, cause the one or more processing devices to generate a web from to display to a user, run a trigger that executes on a specific trigger event, responsive to an occurrence of the specified trigger event, automatically execute a script to dynamically alter the web form, and display the altered web form to the user. An exemplary includes generating a web form to display to a user; running a trigger that executes on a specific trigger event; responsive to an occurrence of the specified trigger event, automatically executing a script to dynamically alter the web form; and displaying the altered web form to the user.

These and other embodiments can optionally include one or more of the following features: the trigger event may be custom validation on a form field; the trigger event may be an end of a specified time period; the trigger event may be specific input received by a certain form field; the trigger event may be based on a collective response to one or more form fields; and an application programming interface may be used to create the trigger event.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating a web form.

FIG. 2 is block diagram of an exemplary web form schema.

FIG. 3 is a block diagram of an exemplary trigger for dynamically changing a web form schema.

FIG. 4 is a block diagram of an exemplary web form schema.

FIG. 5 is a block diagram illustrating a web form.

FIG. 6 is a flow diagram of an exemplary method for using custom functions to dynamically manipulate web forms.

FIG. 7 is an exemplary computing device.

### DETAILED DESCRIPTION

According to an exemplary embodiment, a user building a web form using a web form builder application can create custom functions to dynamically change the content of his or her web form and validate form input. Form content may be dynamically modified using triggers that execute on specific trigger events. A trigger event, for example, may be the occurrence of a specific time period, a form field receiving certain input, a combination of multiple field inputs, or based on a counter or a previous response to a form element. Trigger events may also occur when specific events happen such as receiving an email or accepting a calendar invitation. For example, in one exemplary embodiment, a person may run a script whenever he or she receives an email. The script could be linked to a form action and dynamically change the form when an email is received. In another embodiment, a script may be run when a person responds to a calendar invite. If the person accepts the invitation, the script could send them a form. The script could also add them to a question or add their name to a list of attendees. Trigger events may also show when there has been a change to a spreadsheet or other document. Additionally, trigger events could occur with the receipt of an SMS message. This list of trigger events is merely exemplary and not extensive. Furthermore, scripts do not always require trigger events to occur in order to be run. Scripts may be run manually which dynamically change forms.

In addition to a user interface, an exemplary embodiment may include a script application programming interface (API) that may allow a user building a form to create a script which modifies the form and alters form elements dynamically. In the event registration example discussed above, a user may create a trigger that executes when the one hundredth person registers for the event.

This exemplary trigger runs when the form is submitted. The trigger checks to see how many responses have been received. If the number of responses is greater than one hundred, the trigger deletes the last question of a three-question form.

In an exemplary embodiment, a web form may be created for an event registration as discussed above. The registration form may include data entry for the conference for which a user is registering, the user's first name, the user's last name, a phone number for the user, and the user's company. The web form may additionally include a way to enter a t-shirt size for the first one hundred people who register for a particular event.

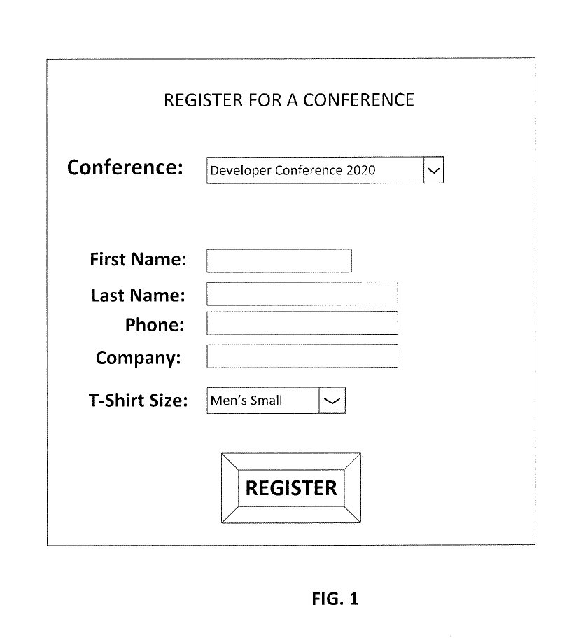

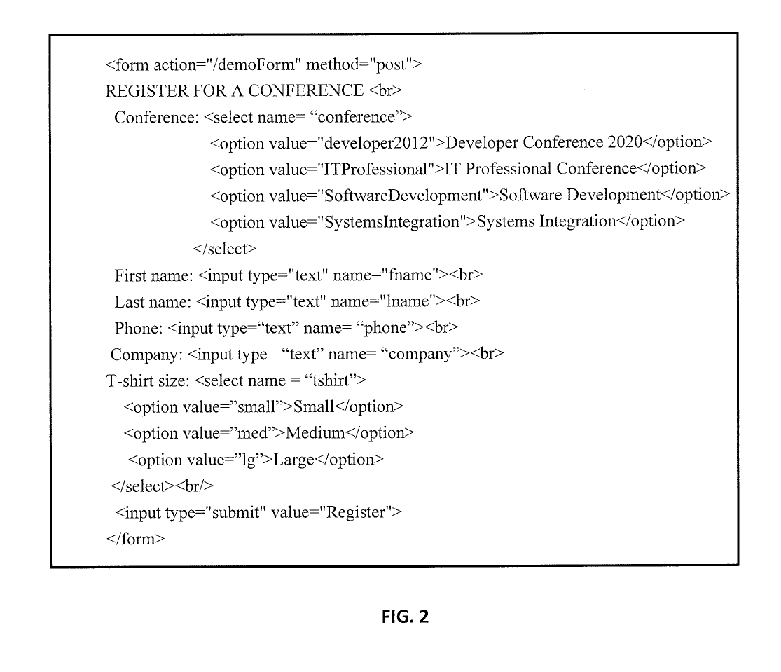

Exemplary code for producing this web form schema may be written as shown in FIG. 2. This code may result in a web form as illustrated by FIG. 1 being shown to an end user.

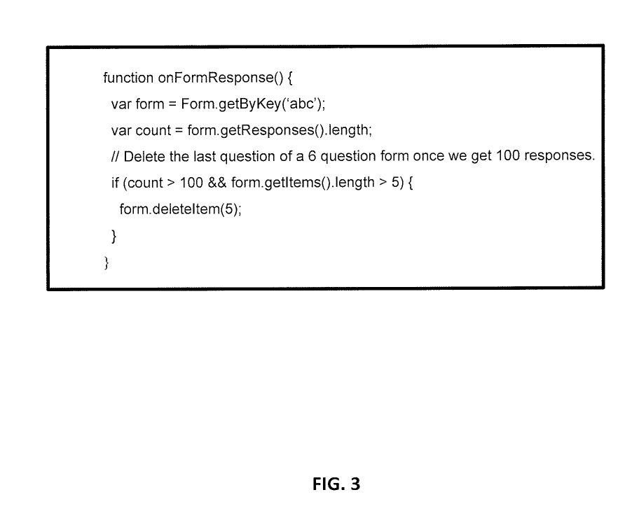

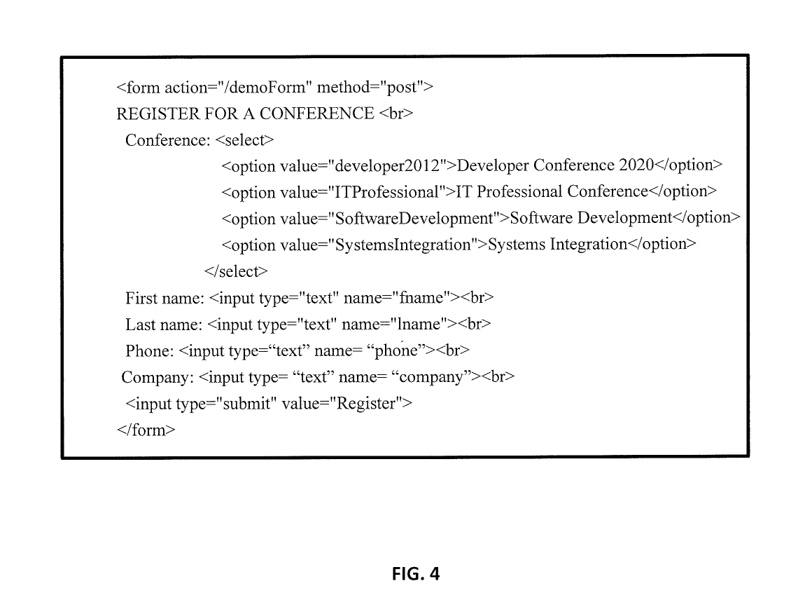

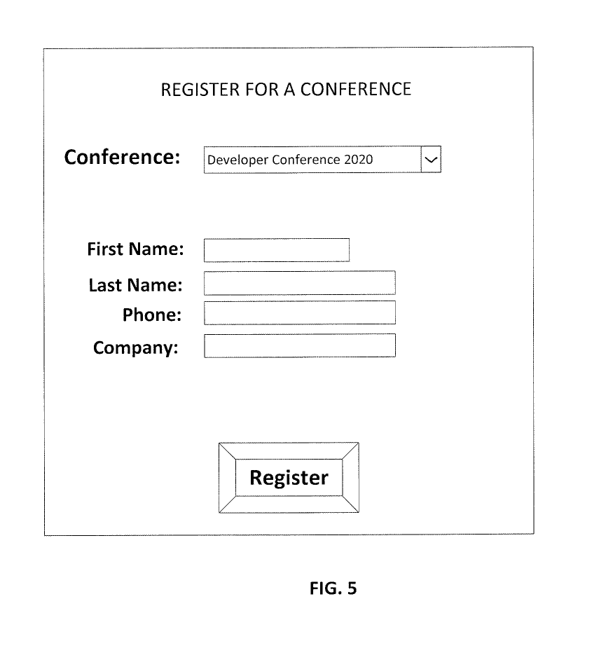

A trigger handler may be written that will run a script to dynamically alter the form to delete form fields related to t-shirt size. An example trigger may be written the following as shown in FIG. 3. The trigger counts how many responses there have been. If there have been more than one hundred responses, the trigger causes the form to delete the form's last field which is the field that holds the registrant's t-shirt size. The web form schema may then be represented by the schema as illustrated in FIG. 4. The form that may be shown to an end user is illustrated in FIG. 5.

Form elements may be automatically changed in a variety of ways. For example, form elements may be hidden, shown, added, deleted, grayed out, checked, unchecked, rearranged, changed in color or size, or a default choice may be selected or pre-filled for a given field based on a script.

A user building a web form may also be able to use scripts to create custom validation for form input. For example, a teacher may generate a quiz for his or her class using a form builder. The teacher may create custom functions for each form input field to analyze whether the response given to each field is correct. When an end user inputs data into a specific form field and submitted, the custom validation runs on the field to determine if the input is valid. A web form may be built to allow data to be incorrectly entered into its form fields and submitted a specific number of times before input can no longer be input into the field. Using the example of a teacher creating a quiz, the teacher could set up the quiz so that each question may be attempted up to three times. After the third time of receiving an invalid response for a given form field, an end user may no longer be able to input a response to that field.

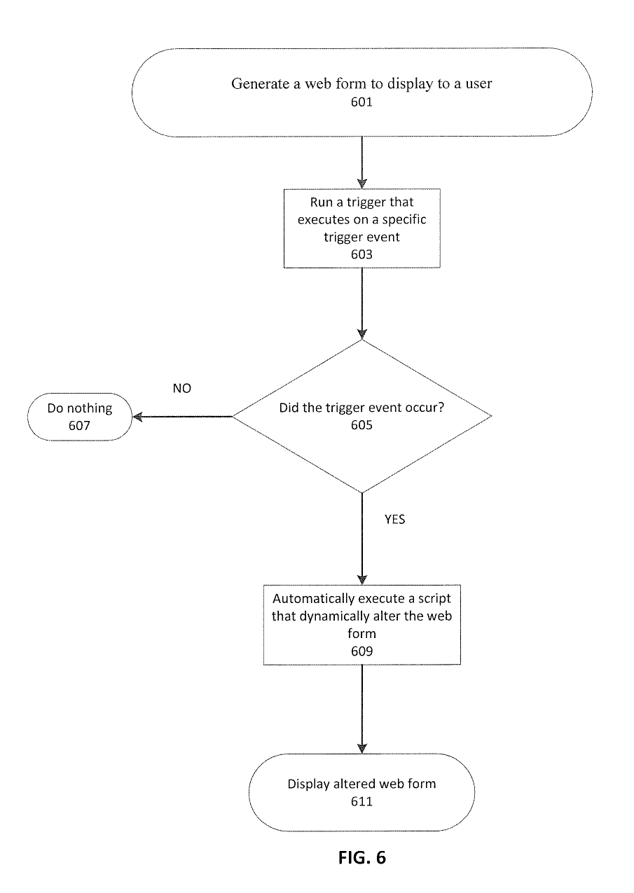

An exemplary method begins with generating a web form to display to a user as illustrated in FIG. 6 (601). A trigger is then run which executes on a specific trigger event (603). If the trigger event occurs, the trigger handler may automatically execute a script that dynamically alters the web form (609). The script may change the web form displayed contents or the web form schema based on the code contained within the script. The altered web form is then displayed to the end user (611).

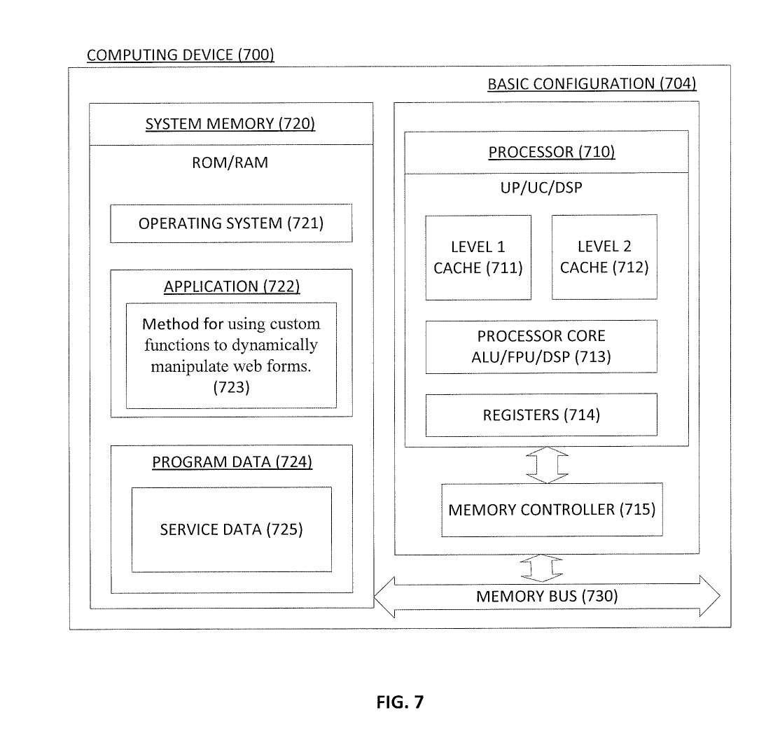

FIG. 7 is a block diagram illustrating an example computing device (700) that is arranged for dynamically manipulating web forms. In a very basic configuration (701), the computing device (700) typically includes one or more processors (710) and system memory (720). A memory bus (730) can be used for communicating between the processor (710) and the system memory (720).

Depending on the desired configuration, the processor (710) can be of any type including but not limited to a microprocessor (AP), a microcontroller (μC), a digital signal processor (DSP), or any combination thereof. The processor (710) can include one more levels of caching, such as a level one cache (711) and a level two cache (712), a processor core (713), and registers (714). The processor core (713) can include an arithmetic logic unit (ALU), a floating point unit (FPU), a digital signal processing core (DSP Core), or any combination thereof. A memory controller (716) can also be used with the processor (710), or in some implementations the memory controller (715) can be an internal part of the processor (710).

Depending on the desired configuration, the system memory (720) can be of any type including but not limited to volatile memory (such as RAM), non-volatile memory (such as ROM, flash memory, etc.) or any combination thereof. System memory (720) typically includes an operating system (721), one or more applications (722), and program data (724). The application (722) may include a method for dynamically manipulating web forms. Program Data (724) includes storing instructions that, when executed by the one or more processing devices, implement a system and method for using custom functions to dynamically manipulate web forms. (723). In some embodiments, the application (722) can be arranged to operate with program data (724) on an operating system (721).

The computing device (700) can have additional features or functionality, and additional interfaces to facilitate communications between the basic configuration (701) and any required devices and interfaces.

System memory (720) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of the device (700).

The computing device (700) can be implemented as a portion of a small-form factor portable (or mobile) electronic device such as a cell phone, a personal data assistant (PDA), a personal media player device, a wireless web-watch device, a personal headset device, an application-specific device, or a hybrid device that include any of the above functions. The computing device (700) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for dynamically modifying a web form in a hosted form application execution environment comprising:
generating a web form to display to a user;
running a trigger that executes on a specific trigger event;
responsive to an occurrence of the specified trigger event, automatically executing a script to dynamically alter the web form; and
displaying the altered web form to the user.

2. The method of claim 1 wherein the trigger event is custom validation on a form field.

3. The method of claim 1 wherein the trigger event is an end of a specified time period.

4. The method of claim 1 wherein the trigger event is specific input received by a certain form field.

5. The method of claim 1 wherein the trigger event is based on a collective response to one or more form fields.

6. A system for dynamically modifying a web form in a hosted form application execution environment comprising:
one or more processing devices; and
one or more storage devices storing instructions that, when executed by the one or more processing devices, cause the one or more processing devices to:
create a defined web form structure; and
create a script to run when a trigger event occurs that alters the defined web form structure.

7. The system of claim 6, wherein an application programming interface is used to create the trigger event.

8. A system for dynamically modifying a web form in a hosted form application execution environment comprising:
one or more processing devices; and
one or more storage devices storing instructions that, when executed by the one or more processing devices, cause the one or more processing devices to:
generate a web form to display to a user;
run a trigger that executes on a specific trigger event;
responsive to an occurrence of the specified trigger event, automatically execute a script to dynamically alter the web form; and
display the altered web form to the user.

9. The system of claim 8, wherein the trigger event is custom validation on a form field.

10. The system of claim 8, wherein the trigger even is an end of a specified time period.

11. The system of claim 8, wherein the trigger event is specific input received by a certain form field.

12. The system of claim 8, wherein the trigger event is based on a collective response to one or more form fields.

13. A non-transitory computer readable medium having stored therein computer executable code that causes one or more processors to execute the steps of:
generating a web form to display to a user;
running a trigger that executes on a specific trigger event;
responsive to an occurrence of the specified trigger event, automatically executing a script to dynamically alter the web form; and
displaying the altered web form to the user.

14. The non-transitory computer readable medium of claim 13, wherein the trigger event is custom validation on a form field.

15. The non-transitory computer readable medium of claim 13, wherein the trigger event is an end of a specified time period.

16. The non-transitory computer readable medium of claim 13, wherein the trigger event is specific input received by a certain form field.

17. The non-transitory computer readable medium of claim 13, wherein the trigger event is based on a collective response to one or more form fields.
